(19) United States
(12) Patent Application Publication
(10) Pub. No.: US 2005/0181766 A1
(43) Pub. Date: Aug. 18, 2005

(54) Method and device for delivering messages to mobile terminal devices in accordance with a user selectable attainability status

(76) Inventors: Michael Rooke, Hyvinkkaa (FI); Teppo Savinen, Vihti (FI); Tapio Holopainen, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/512,101

(22) PCT Filed: May 6, 2003
(86) PCT No.: PCT/IB02/01518

(51) Int. Cl. H04Q 7/20

(52) U.S. Cl. 455/412.1; 455/466

(57) ABSTRACT

Method and device for delivering messages to mobile terminal devices in case of an unsuccessful message delivery attempt to said mobile terminal device from a Store-and-Forward Entity of a mobile communication network. The method comprises the reception of a notification about an unsuccessful delivery attempt of a message, followed by a subscription to a presence service for future notifications of the status of a terminal device. The method and a device is provided for executing a communication attempt following an unsuccessful delivery attempt of a message to a mobile terminal device in a communication network when presence of the terminal device is determined. This invention allows the conventionally necessary multiple delivery attempts to be reduced to just one. The Store-and-Forward Entity does this by subscribing to the presence service in case a failed mobile terminated delivery attempt so that multiple delivery attempts are not performed.

### CROSS-REFERENCE TO RELATED APPLICATION

This application is the U.S. National Stage of International Application Number PCT/IB02/01518 filed May 6, 2002 and published in the English language on Nov. 13, 2003 under International Publication Number WO 03/094553 with International Search Report.

### BACKGROUND OF THE INVENTION

1. Technical Field

The present invention relates to cellular communication networks having the capability to transmit messages such as multi media messages, short messages, and the like. It also relates to a method for delivering messages in accordance with an attainability status of a mobile terminal device selectable by a user. The present invention relates to a method to initiate message delivery attempts to mobile terminal devices with a minimized waste of network resources. The invention further relates to a mechanism inside a Multimedia Message Service Center (MMSC), a Short Message Service Center (SMSC), or a Store-and-Forward Entity (SFE) to provide notifications for calling applications or network devices for informing them, if mobile devices are going to accept incoming messages or not.

2. Discussion of Related Art

Currently, if a mobile terminal device is connecting to a network, a notification is sent to a presence service in the network, so that the network is informed, if the handset is reachable or not. This is executed independently of the presence of a message to be transferred. An SFE in the network usually repeatedly starts delivery attempts until the message can be delivered and a confirmation notification is received. In case the message can not be delivered, the amount of data to be transferred for the multiple delivery attempts of a single message may increase unnecessarily. So it would be desirable to reduce these unsuccessful message delivery attempts, to save network resources. Additionally, a user does not have the choice to reject incoming short messages or multi media messages except when turning off the mobile terminal device. Otherwise he may risk an overflow of the message memory of his terminal device. Typically, a server would subscribe to a user's presence information, and when the presence status changes it will be notified and can take appropriate actions before delivering a message. The problem here is that the server e.g. MMSC must subscribe to the presence information for every user in the network.

Sometimes it would be desirable for a user to be able to select the attainability status of his mobile terminal device, in accordance with the available communication channels. Presently, the Short Messages (SMs) are sent to the terminal device anyway, and there is presently no way, e.g. in the European Telecommunication Standard Institute (ETSI) specifications, for the user to reject the reception of certain kind of messages.

The standard procedures for delivering SMs can be found in the ETSI specifications for Global System for Mobile Communications (GSM) for Short Messages Service (SMS). The standard procedures for delivering multimedia messages (MMs) are going to be found in the ETSI specifications for Multimedia Messaging Services (MMS) of the 3rd Generation Partnership Project (3GPP).

### DISCLOSURE OF THE INVENTION

It is desirable to reduce unnecessary data transfer in mobile communication networks, in the case of a failed delivery attempt of a message.

It is further desirable to have a method and a device capable of determining, if a user is willing to receive messages on his mobile terminal device.

According to one embodiment of the invention a method is provided, for managing a message to be transmitted to a mobile terminal device from a Store-and-Forward Entity (SFE) of a mobile communication network, in the case that the message could not be delivered during the first delivery attempt. According to this embodiment of the invention, a method for delivering messages to a mobile terminal device is provided for proceeding with the delivery of a message by receiving a notification about an unsuccessful delivery attempt of a message and subscribing to notifications from a presence service. The present method is to reduce the data transferred if a single message cannot be delivered during the first delivery attempt.

The notification about an unsuccessful delivery attempt is sent to the SFE from the communication network (CN), and the SFE is no longer occupied with the delivery of said message, as it is now subscribed to a presence service to tell when the next delivery attempt is to be performed. The main advantage is that this subscription is transmitted only once, if a message could not be successfully transmitted in the first attempt. If a device is not available or will not accept a message, only one subscription to the presence service to be notified is transmitted to the presence service, instead of multiple delivery attempts to be performed. Naturally, the SFE may further comprise internal timers to discard a message after a predetermined time, to prevent a SFE memory overflow.

The best example for illustrating this would be a mobile phone user, who is receiving MMs only periodically, but is frequently using the subway. A mobile terminal device of such a user may be not available for three to four times a day but may receive only one message a week. Such a behavior of a user leads to two different scenarios: A permanent notification about the availability of the user device can lead to the fact that the availability notifications from the presence service outnumber the message delivery attempts. Additionally the system can not predict when the user will be available again, so a large number of delivery attempts may be necessary to deliver a single message. Preferably, the use of the method for transmitting messages may be related to a number of messages and changes in availability of said mobile terminal device. So the best and most effortless method for delivering messages can be chosen.

Advantageously, the method further comprises, receiving a presence service status change message about said mobile terminal device of a change of said availability information, and starting a delivery attempt of said message to said mobile terminal device in accordance with said received presence service status change message.

Advantageously, said messages are multi media messages. The method may be applied to any other message type in said communication network. The more different types of messages are available, the more efficient the method can be used.

The less different types of messages are available, the simpler the use of the method is.

In accordance with the invention the method further comprises: receiving of a message destined for a mobile terminal device. This receiving step enables the method to operate fully store-and-forward. This paragraph is only to emphasize that the method can be applied to messages received for forwarding and to messages generated in the SFE. So in the case of e.g. a terminal device classified as unwilling to receive MMs, the SFE may generate an SMS to inform the terminal of MMs waiting for delivery.

Conveniently, the method further comprises the checking of availability information of said mobile terminal device via a presence service for the availability of said mobile terminal device. This step is corresponding to the checking of the HLR (home location register) in the case of the SMS (short message system).

According to one embodiment of the invention a method is provided, for managing a message to be transmitted to a mobile terminal device from a Store-and-Forward Entity (SFE) of a mobile communication network. The method comprises the checking of availability information of said terminal device with a presence service for the acceptance of said message by said terminal device, and, starting a delivery attempt of said message to said terminal device, in accordance with the result of said checking. This checking of the acceptance of said message by said mobile terminal device in the communication network can be performed simultaneously with said checking of the availability/presence of said mobile terminal device or prior or after said checking of the availability/presence of said mobile terminal device.

By checking a service for the acceptance of a message by said mobile terminal device, the usually performed checking of the presence or the availability of said mobile terminal device may be economized. It is possible to reduce the signaling load to the SFE present in the network, as the whole data traffic for updating the presence service can be reduced. The updating of the presence service may even only be performed, if a message is to be send or transmitted.

The store and forward entity (SFE) can be e.g. a SMSC (Short message service center), a MMSC (multi media message service center) or an evolutionary combination for future networks wherein the individual roles of the SMSC and MMSC are likely to be combined in a single “Store-and-forward Service Center” SFSC that is connected to at least one communication network. The SFE can be incorporated in a service center for other services e.g. a news service or in a gateway connected to multiple communication networks, such as the internet, mobile communication networks, cellular phone networks, or local area networks, like Bluetooth or LAN/WLAN. The method is performed by querying a presence service in or connected to said SFE, for obtaining a presence information of said mobile terminal device, if it is going to accept said message. It is to be noted that the term “accepting” is chosen to emphasize that not only the ability of the mobile terminal device is queried but even other criteria are used to detect the acceptance for said message. The presence service can be incorporated in the SFE or can be incorporated in a server connected to the SFE via said communication network.

Preferably, said availability information for the acceptance of said messages by said mobile terminal device comprises information selected from the group of: type of message, size of the message, data contents of the message, location of said mobile terminal device and willingness of the user of said mobile terminal device to receive a message. By using such differentiated information for the acceptance of a message, said presence service can be used as a filter to select certain messages not to be transmitted e.g. different messages such as MMS, SMS or any other message type to be developed.

Preferably, said availability information for acceptance for said message depends on the properties of said message. Conveniently, said properties are selected from the group of: message type, message size, sender type, and sender. This feature enables a user of a mobile terminal device to select different types of messages to be delivered directly, e.g. all text messages without graphic elements, so as to save memory space of the mobile terminal device or the like. This feature also enables a user to select or to reject messages from a certain sender which usually transmits e.g. advertisements, or to suppress the delivery of sound data as the mobile terminal may not be capable of processing these data. The feature makes specific filtering available at the presence service or the presence server.

Conveniently, said availability information of said mobile terminal device in said presence service can arbitrarily be changed by receiving a presence service status change message from said mobile terminal device. The main advantage of said message is the ability to freely select an availability status, so that a user can decide and select what, and what kind of message he wants to receive. The message can be sent directly from the mobile phone, or maybe from any device authorized to perform the change in the presence service. This enables a user to e.g. use an internet access point to change or optimize the entries in the presence service of his mobile terminal device.

According to another aspect of the present invention, a software tool for initiating a delivery attempt of a message to a mobile terminal device in accordance with the availability status of said mobile terminal device in a presence service of a communication network is provided, which comprises program code means for performing all of the steps of the preceding description when said program is run on a SFE or a network device.

According to another aspect of the present invention, a computer program for executing a delivery attempt of a message to mobile terminal device in accordance with the availability status of said mobile terminal device in a communication network is provided, which comprises program code means for performing all of the steps of the preceding description when said program is run on a SFE or a network device.

According to yet another aspect of the invention, a computer program product is provided, comprising program code means stored on a computer readable medium for carrying out the method for executing a delivery attempt of a message to a mobile terminal device in accordance with an acceptance information of said mobile terminal device in a cellular communication network is provided by the preceding description when said program product is run on a computer or a network device.

According to another embodiment of the invention a Store-and-Forward Entity (SFE) is provided, that is capable of executing the method of the preceding description. The SFE is connected to a communication network that comprises a presence service, which can e.g. be incorporated in a respective presence server. The SFE is characterized by: a component for receiving a notification about an unsuccessful delivery attempt of a message, and a component for subscribing to said presence service for future notifications of the attainability status.

Preferably, the SFE further comprises a component for checking availability information of a presence service for the acceptance of said message by said mobile phone. The SFE further comprises a component to perform a delivery attempt of said message to said mobile terminal device. These both components enable the SFE to determine the acceptance to receive a certain message by said mobile terminal device.

Preferably, the SFE further comprises a component for checking availability information of a presence service for the availability of said mobile terminal device. This component can be an independent component or may be combined with said component to check the acceptance of said message in a single check presence information component.

Advantageously, said SFE further comprises a component to receive messages to be delivered to said mobile terminal device. This component enables a fully store-and-forward capability, enabling the SFE to operate as a Store-and-Froward Service Center. Preferably, the component to receive messages is capable to receive messages from an other communication network than that to which the terminal device is connected. This would provide some kind of MMS-GSMC Multimedia Message System—Gateway Mobile service Switching Center or a SFE-GMSC, a Store-and-Forward Entity—Gateway Mobile service Switching Center. It may be noted that the SFE according to the present invention can be incorporated e.g. in a personal mobile gateway device, too, and is not only restricted to cell-phone and internet.

Conveniently, said SFE further comprises a component to subscribe to the presence service. This embodiment of the present invention can be utilized, if a direct notification to the presence service is not intended.

Advantageously, said presence service contains information for acceptance of said message, which depends on at least one information selected from the group of: message type, message size, sender type, sender, the location of said mobile terminal device, and maybe the willingness of the user of said mobile terminal device to receive a certain type of message. The presence service for the acceptance of messages may also be used as some kind of a message reception filter.

Preferably, said SFE further comprises a component to change said availability information in said presence service of said mobile terminal device according to the reception of a presence service status change message from said mobile terminal device.

### BRIEF DESCRIPTION OF THE DRAWINGS

In the following, the invention will be described in detail by referring to the enclosed drawings in which:

FIG. 1 is a flowchart of a successful delivery of a MMS in a communication network, according to the present invention, and

FIG. 2 is a flowchart of a failed delivery attempt of a message according to one embodiment of the present invention.

### BEST MODE FOR CARRYING OUT THE INVENTION

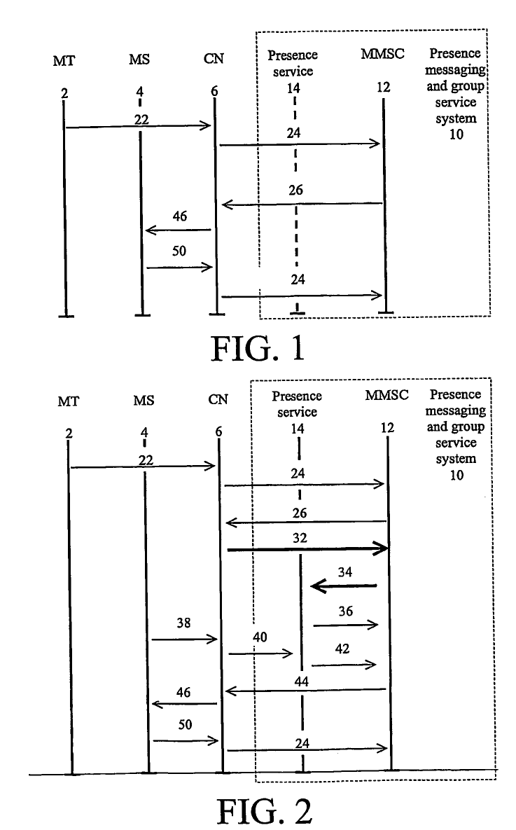

FIG. 1 is a flowchart of a successful delivery of a MMS in a communication network. In the first step a mobile terminal 2 transfers 22 a multimedia message (MM) to a communication network (CN) 6. The communication network 6 can be one or more base transceiving systems, base stations, repeaters or service providers or any other relaying elements in the respective communication network. The message is transferred from the CN 6 to the Multimedia Message Service Center (MMSC) 12 (in the role of said SFE) in the presence messaging and group services system 10 (Presence Messaging and Group System). This describes that the mobile terminal 2 submits a message to the store and forward entity 12. The presence messaging and group services system 10 is depicted to indicate that the method is not restricted to a single communication network, but can be applied to communication network clusters, of different communication networks connected via gateways such as e.g. personal mobile gateways, too. Then a message delivery is attempted.

The MMSC 12 directly transfers the message back to the CN 6, after requesting availability information from the presence service 14. The presence service 14 can be incorporated in a presence server, or may be incorporated in the MMSC 12 in the network. The CN 6 in turn transfers 46 the message to the mobile station 4. The mobile station 4 returns 50, 24 a confirmation about the successful delivery of said message to the MMSC 12 via the CN 6. A normal message delivery identifies the problem area: If the mobile station 4 is not available the message will fail, the MMSC 12 must therefore subscribe to every user/mobile station presence information from a presence service 14, before attempting a delivery (not shown). In reality this means even, if the MMSC 12 is not delivering a message, it will still receive traffic relating to the presence of a user or a mobile station and hence the traffic load here may actually be more than that normally used to delivery messages.

FIG. 2 is a flowchart of a failed delivery attempt of a MM in a communication network. The first steps of the method are basically the same as in FIG. 1. In the first step a mobile terminal 2 transfers 22 a multimedia message to a base station or CN 6. The message is transferred 24 from the CN 6 to the MMSC 12 in the presence messaging and group services system 10. The MMSC 12 directly transfers 26 the message back to the CN 6, which in turn tries to transfer the message to the mobile station 4. The message delivery will sometimes fail and at this point the MMSC 12 (in the role of the SFE) contacts the presence server to subscribe to the messaging presence information. The transfer of the message fails, and the CN 6 returns “failed delivery” response 32 back to the MMSC 12. Following that, the MMSC 12 will request to be informed of a notification 34 to the presence service 14 regarding the availability of said mobile station 4. The presence service 14 returns a confirmation 36 of said change in the availability status back to the MMSC 12. The MMSC 12 waits for a notification about a change in the availability status of the mobile station 4 in the presence service 14.

At some point in the future, the receiving MS of the message will perform an update about its messaging presence information: If the mobile station 4 changes its availability status, it notifies 38, 40 the presence service 14 about the change in the availability status, via the CN 6. When notified, the presence service 14 notifies 42 the MMSC 12 of the change. The presence server will then notify the MMSC 12 (per subscription, the MMSC 12 does not receive ALL the presence information changes, but only this particular MS 4 in this case). The MMSC 12 starts a further delivery attempt 44, 46 of the message to the mobile station 4 via the CN 6. The MMSC 12 will attempt message delivery, which should succeed knowing the MS 4 is present. As in FIG. 1, the mobile station 4 returns 50 a confirmation about the successful delivery of said message to the MMSC 12 via the CN 6. The notification of the change can also be transferred from the mobile station 4 to the presence service 14 via the MMS 12. It is also optional at this point that the MMSC 12 unsubscribes to the presence information, because the MMSC 12 does not want to receive any further message presence notifications of MS 4.

In case of a failed delivery attempt, a subscription/notification to the presence service/server is triggered. This is an important aspect of the present invention, to entrust another entity of the network to report that a device is able to receive a message. This reduces the operations and the transmissions necessary for a successful delivery of a message. To emphasize this point, the respective arrows 32, 34 in the FIG. 2 are depicted bold. Here the MMSC 12 attempts delivery without prior knowledge of the state of the mobile terminal device, if the mobile terminal device is online/available the message is successful as identified in FIG. 1, otherwise it will fail and trigger a request from the MMSC to the presence service for the subscribers presence. Once the mobile terminal device/subscriber is available the presence server is notified from the mobile terminal device/subscriber. The presence server then notifies the MMSC and the MMSC attempts the message delivery.

It is to be noted that the subscription request 34 from the MMSC 12 to the presence service 14 about availability of said mobile station 4 stated here is generic. It is to be noted, that further enhancement of this method can include subscription to attributes specific to messaging, for example: Subscribe to the user presence only for multimedia messaging. Here the notifications are only relating to MMS.

Because of the subscription to the presence information, it is not longer necessary to perform the delivery attempts all the time. The delivery attempts are only performed when a notification from the presence server is received. So the number of delivery attempts are reduced and hence the traffic is reduced.

It should further be noted that messages flowing above have been assigned generic names, they can quite easily be mapped to Session Initiation Protocol (SIP) specific message types, e.g. NOTIFY and SUBSCRIBE. An UN-Subscribe may also be requested from the MMSC 12 to the presence service 14 once the message has been delivered to the mobile terminal 4.

It is further to be noted that the expressions “mobile terminal device” and “mobile station” are used synonymously.

It is further to be noted, that in the present invention the presence services for the presence of said mobile terminal device and for the acceptance of a message by said terminal device can be integrated in a single presence service, or may be incorporated in different devices in the network.

This application contains the description of implementations and embodiments of the present invention with the help of examples. It will be appreciated by a person skilled in the art that the present invention is not restricted to details of the embodiments presented above, and that the invention can also be implemented in another form without deviating from the characteristics of the invention. The embodiments presented above should be considered illustrative, but not restricting. Thus the possibilities of implementing and using the invention are only restricted by the enclosed claims. Consequently various options of implementing the invention as determined by the claims, including equivalent implementations, also belong to the scope of the invention.

1. Method for delivering messages to a mobile terminal device in case of an unsuccessful message delivery attempt to said mobile terminal device from a Store-and-Forward Entity (SFE) of a mobile communication network having a presence service, said presence service providing an information about the attainability of said mobile terminal device, characterized by:
receiving a notification about an unsuccessful delivery attempt of said message, and
subscribing to said presence service for receipt of notifications about the attainability of
said mobile terminal device,
checking availability information of said mobile terminal device in said presence service for an acceptance of said message by said mobile terminal device,
initiating a delivery attempt of said message to said mobile terminal device, in accordance
with the result of said checking,
wherein said availability information for the acceptance of said messages by said mobile terminal device comprises information selected from a group of: type of message, size of the message, data content of the message, location of said mobile terminal device and willingness of a user of said mobile terminal device to receive a message.

2. Method according to claim 1, further comprising:
receiving a status change notification message from said presence service about said
mobile terminal device having a change of said availability information,
starting a delivery attempt of said message to said mobile terminal device, in accordance
with said received status change notification message.

3. Method according to claim 1, wherein said message is a multi media message.

4. Method according to anyone of the claim 1, further comprising receiving of said message to be transmitted to said mobile terminal device.

5. Method according to claim 1, further comprising checking availability information of said mobile terminal device in said presence service for the availability of said mobile terminal device.

6. Method according to claim 1, wherein said availability information for acceptance of said message is depending on properties of said message.

7. Method according to claim 6, wherein said properties are selected from a group comprising: message type, message size, sender type, and sender.

8. Method according to claim 1, wherein said availability information of said mobile terminal device in said presence service can arbitrarily be changed by receiving said presence service status change message from said mobile terminal device.

9. Software tool for performing a delivery attempt of a message to a mobile terminal device in accordance with the information related to the availability status of said mobile terminal device in a communication network, comprising program code means for carrying out the steps of claim 1 when said software tool is implemented in a program run on a Store-and-Forward Entity or a network device.

10. Computer program for performing a delivery attempt of a message to a mobile terminal device in accordance with the availability status of said mobile terminal device in a communication network, comprising program code means for carrying out the steps of claim 1 when said program is run on a Store-and-Forward Entity or a network device.

11. Computer program product comprising program code means stored on a computer readable medium for carrying out the method of claim 1 when said program product is run on a Store-and-Forward Entity or a network device.

12. Store-and-Forward Entity connectable to a mobile communication network having a presence service for store-and-forwarding a message to a mobile terminal device, characterized by:
a component for receiving a notification about an unsuccessful delivery attempt of said
message, and
a component for subscribing to said presence service for receipt of notifications about the
attainability status of said mobile terminal device, and
said presence service,
wherein said presence service provides an information about acceptance of said message selected from the group comprising: message type, message size, message content, sender type, sender, and location of said mobile terminal device.

13. Store-and-Forward Entity according to claim 12, further characterized by:
a component for checking availability information of a presence service for an acceptance
of said message by said mobile phone, and
a component to initiate a delivery attempt of said message to said mobile terminal device, in accordance with the operation of said checking component.

14. Store-and-Forward Entity according to claim 13, further comprising a component for checking availability information of said presence service for the availability of said mobile terminal device.

15. Store-and-Forward Entity according to claim 13, further comprising a component for receiving messages to be transmitted to said mobile terminal device.

16. Store-and-Forward Entity according to claim 12, further comprising a component to change said availability information in said presence service of said mobile terminal device according to the reception of a presence service status change message from said mobile terminal device.
